(19) United States
(12) Patent Application Publication
(10) Pub. No.: US 2011/0101666 A1
(43) Pub. Date: May 5, 2011

(54) BOOKLET

(76) Inventors: Tetsurou Tamaki, Osaka (JP); Takaaki Kiyose, Osaka (JP); Akira Tanaka, Osaka (JP); Takashi Oda, Osaka (JP)

(21) Appl. No.: 12/737,361

(22) PCT Filed: Jul. 30, 2009
(86) PCT No.: PCT/JP2009/063546

§ 371 Date: Jan. 5, 2011

(30) Foreign Application Priority Data
Jul. 31, 2008 (JP) 2008-199029

(51) Int. Cl. B42D 1/00

(52) U.S. Cl. 281/3.1

(57) ABSTRACT

Provided is a booklet including: a plurality of leaves 2; a spine 4 that couples bound edges of the leaves 2 via a flexible glue layer 3; and a front cover 5 and a back cover 6 each having at least an entire area of a surface portion continuing to an entire area of a surface portion of the spine 4, wherein a flexural strength of the spine 4 backed by the glue layer 3 is set such that the spine 4 is flexibly deformed inwardly at a near acute angle together with the bound edges of the leaves 2 when center pages of the leaves 2 are spread.

### TECHNICAL FIELD

The present invention relates to a booklet.

### BACKGROUND ART

Conventionally, there have been known various booklets that each include a plurality of leaves, and a front cover, a spine, and a back cover of which surfaces are continuously provided. A typical booklet that is relatively inexpensive is such that bound edges of the plurality of leaves are coupled to a spine via a rigid glue layer (a major example of such a glue is a hot-melt adhesive) that is inflexible or having poor flexibility (see Patent Documents listed below, for example). Further, there are case-bound books in which bound edges of a plurality of leaves are bound using a thread, and the plurality of leaves are covered with a relatively hard front cover, a spine, and a back cover that are continuously provided while maintaining flexibility of the bound edges, but this type of booklets are expensive.

### PRIOR ART DOCUMENTS

### Patent Documents

Patent Document 1: Japanese Unexamined Patent Publication No. H10-129147
Patent Document 2: Japanese Unexamined Patent Publication No. H10-129148

### SUMMARY OF THE INVENTION

### Problem to be Solved by the Invention

However, as a booklet using the hot-melt adhesive is bound by coupling the plurality of leaves to the spine via the glue layer with poor flexibility, the spine itself is hard to deform, and portions near the bound edges of the leaves are elevated (lifted) when two pages are spread, thereby posing a problem of poor two-page spread quality.

On the other hand, although the case-bound book is superior in terms of the two-page spread quality than the booklet using the hot-melt adhesive, the spine itself mainly serves to cover the leaves and not to couple the bound edges of the plurality of leaves, and a work is necessary to attach the front cover, the spine, and the back cover that are continuously provided in addition to a work of binding the bound edges of the plurality of leaves using the thread, thereby posing a problem of making a production process cumbersome.

The present invention is made in view of the above problem, and a main object of the present invention is to provide a booklet having superior two-page spread quality while simplifying the production process.

### Means for Solving the Problem

Specifically, a booklet according to the present invention includes: a plurality of leaves; a spine that couples bound edges of the leaves via a flexible glue layer; and a front cover and a back cover each having at least an entire area of a surface portion continuing to an entire area of a surface portion of the spine, wherein a flexural strength of the spine backed by the glue layer is set such that the spine is flexibly deformed inwardly at a near acute angle together with the bound edges of the leaves when center pages of the leaves are spread.

To be more precise, the flexural strength of the spine backed by the glue layer is set such that a spread width between the spine and the back cover and a height of the covers from a flat plane are measured in a state in which a weight of 100 gf is placed on the booklet that is placed on the plane having a flat and even surface with the glue layer upside, and that a spread angle calculated using the spread width and the height is from 150 degrees to 180 degrees.

With such a structure, it is possible to ensure favorable two-page spread quality as the spine is flexibly deformed inwardly at a near acute angle together with the bound edges of the leaves when center pages of the leaves are spread, and it is also possible to eliminate a production step of binding the plurality of leaves using a thread as the bound edges of the leaves are coupled to the spine via the flexible glue layer, thereby simplifying a production process and reducing the cost therefor in comparison with case-bound books. In addition, as the entire areas of the surface portions of the front cover, the spine, and the back cover are provided continuously to each other, the front cover, the spine, and the back cover can be printed continuously with data of a common image, a character string, or the like, or can be provided with common surface processing such as embossing or making the surfaces to look like real leather or cloth, for example, thereby providing a design with a sense of coherence to an appearance of the booklet, and thus it is possible to provide the booklet with a high value added, such as a unique booklet or a high-grade booklet in order to respond to various demands.

In order to effectively reduce time and efforts of production, a coupling portion of the leaves including the spine and the glue layer can constitute an adhesive binding structure.

In particular, if a plurality of units of leaves, each unit being configured by a twofold sheet along a perforation, are bound in a state in which a part of a cold type glue that forms the glue layer is intruded into the perforations, it is possible to improve a coupling strength between each leaf and the spine while ensuring sufficient flexibility for the spine to be flexed when spread in two pages, thereby providing superior durability. The cold type glue can be used as it is without heating.

In a preferred embodiment, the spine is configured by a single flexible sheet that is directly in contact with the glue layer, and the front cover and the back cover are respectively configured by flexible sheets each continuing to the flexible sheet for the spine, and reinforcement sheets respectively layered on inner surfaces of the flexible sheets. With such a structure, it is possible to exert a protective function for the leaves by the spine, the front cover, and the back cover, while simplifying the structure.

Further, in another preferred embodiment different from the above embodiment, the spine is configured by an inner flexible sheet for the spine which is directly in contact with the glue layer and an outer flexible sheet for the spine which is applied to an outer surface of the inner flexible sheet, and the front cover and the back cover are respectively configured by flexible sheets each continuing to the outer flexible sheet for the spine and reinforcement sheets respectively layered on inner surfaces of the flexible sheets. With such a structure, it is possible to exert a protective function for the leaves by the spine, the front cover, and the back cover that are respectively two-layered.

In these preferred embodiments, especially in the latter embodiment, it is desirable that the plurality of leaves, the inner flexible sheet for the spine which couples bound edges of the leaves via the flexible glue layer, the reinforcement sheet for the front cover of which outer end surface on the side of the bound edges is joined to one end edge of the inner flexible sheet, and the reinforcement sheet for the back cover of which outer end surface on the side of the bound edges is joined to the other end edge of the inner flexible sheet constitute a booklet main body, and the flexible sheet for the front cover, the outer flexible sheet for the spine, and the flexible sheet for the back cover which are provided continuously to each other are applied to an entire area of an outer surface of the booklet main body. With such a structure, it is possible to produce unitized booklet main bodies in advance, and to produce booklets of the number as required by each applying, to the booklet main body, the flexible sheet for the front cover, the outer flexible sheet for the spine, and the flexible sheet for the back cover which are redesigned on demand, thereby reducing an excessive stock.

If the spine is configured by the outer flexible sheet and the inner flexible sheet that is thinner than the outer flexible sheet, it is possible to unitize the booklet main body by the inner flexible sheet, and the outer flexible sheet for the spine can function as a backup member for the inner flexible sheet, thereby providing the booklet having good durability.

Further, if the flexible sheet for the front cover, the outer flexible sheet for the spine, and the flexible sheet for the back cover which are provided continuously to each other are applied to the entire area of the outer surface of the booklet main body using an adhesive containing no moisture, it is possible to prevent occurrence of an unnecessary warpage that may occur especially in the front cover and the back cover in a case where an adhesive containing moisture is used. In this specification, the adhesive has a concept including an adhesion bond.

In particular, if the adhesive is applied to the inner surfaces of the flexible sheet for the front cover, the outer flexible sheet for the spine, and the flexible sheet for the back cover in a dotted pattern, is possible to let air to escape in application of the flexible sheet for the front cover, the outer flexible sheet for the spine, and the flexible sheet for the back cover to the entire area of the outer surface of the booklet main body with no bubbles being left, thereby forming the front cover, the spine, and the back cover with a clean finish.

In order to realize good texture and hand feeling, it is possible to employ paper coated with a resin coating as a material of the flexible sheet.

Further, if each leaf includes ruled lines for writing, it is possible to secure a writing area by the ruled lines, thereby providing a booklet suitable for writing.

Moreover, as the booklet suitable for writing, there is exemplified a booklet including: a plurality of leaves; a spine that couples bound edges of the leaves via a flexible glue layer; and a front cover and a back cover each having at least an entire area of a surface portion continuing to an entire area of a surface portion of the spine, wherein a flexural strength of the spine backed by the glue layer is set such that, when center pages of the leaves are spread, the spine is flexibly deformed inwardly at a near acute angle and an entire area of the front cover and an entire area of the back cover are substantially flush with each other. With such a structure, the entire areas or substantially entire areas of the front cover and the back cover are in contact with a common flat plane when spread in two pages, and therefore it is possible to improve two-page spread quality, to stably maintain a two-page spread state, and, in particular, to facilitate appropriately writing onto an area near the bound edges of the leaves.

### ADVANTAGEOUS EFFECTS OF INVENTION

As described above, according to the present invention, it is possible to provide a booklet having superior two-page spread quality while simplifying a production process.

### BRIEF DESCRIPTION OF THE DRAWINGS

FIG. 1 is an entire perspective view of a booklet according to a first embodiment of the present invention.

FIG. 2 is an entire perspective view illustrating the booklet according to this embodiment in a two-page spread state.

FIG. 3 is a view schematically illustrating an enlarged cross-section of a main portion of the booklet according to this embodiment.

FIG. 4 is a view illustrating the booklet substantially in an intermediate state between a closed state and the two-page spread state when viewed from a rear side according to this embodiment.

FIG. 5 is a view schematically illustrating the booklet according to this embodiment in a two-page spread state.

FIG. 6 is a view illustrating the enlarged main portion illustrated in FIG. 5 in association with FIG. 3.

FIG. 7 is a view illustrating a different magnitude of flexible deformation of a spine from that illustrated in FIG. 6 when the booklet according to this embodiment is spread in two pages.

FIG. 8 is an entire perspective view of a booklet according to a second embodiment of the present invention.

FIG. 9 is an entire perspective view illustrating the booklet according to this embodiment in a two-page spread state.

FIG. 10 is a view schematically illustrating an enlarged cross-section of a main portion of the booklet according to this embodiment.

FIG. 11 is a view illustrating the booklet substantially in an intermediate state between a closed state and the two-page spread state when viewed from a rear side according to this embodiment.

FIG. 12 is an exploded perspective view illustrating the booklet according to this embodiment.

FIG. 13 is a view schematically illustrating the booklet according to this embodiment in a two-page spread state.

FIG. 14 is a view illustrating the enlarged main portion illustrated in FIG. 13 in association with FIG. 11.

FIG. 15 is a view illustrating a modified example of the booklet according to the present invention in association with FIG. 3.

FIG. 16 is a view illustrating a measurement technique of measuring a flexural strength of the spine that is backed by a glue layer.

FIG. 17 is a table showing an example of results of a measurement test on the flexural strength of the spine.

FIG. 18 is a table showing an example of results of a measurement test on the flexural strength of the spine.

### MODES FOR CARRYING OUT THE INVENTION

The following describes one embodiment of the present invention with reference to the drawings.

### First Embodiment

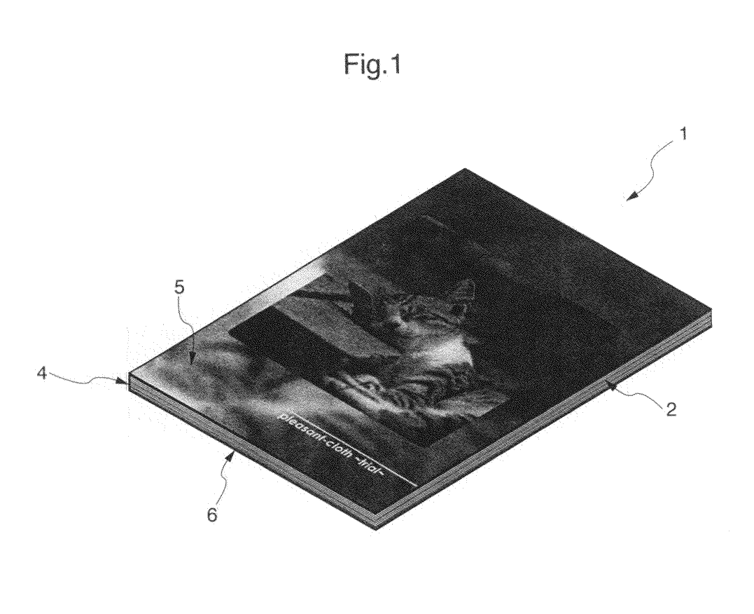

As illustrated in FIG. 1 to FIG. 4 and the like, a booklet 1 according to a first embodiment includes a plurality of leaves 2, a spine 4 that couples bound edges of the leaves 2 via a flexible glue layer 3, and a front cover 5 and a back cover 6 of which entire surface portions are provided continuously to an entire surface portion of the spine 4.

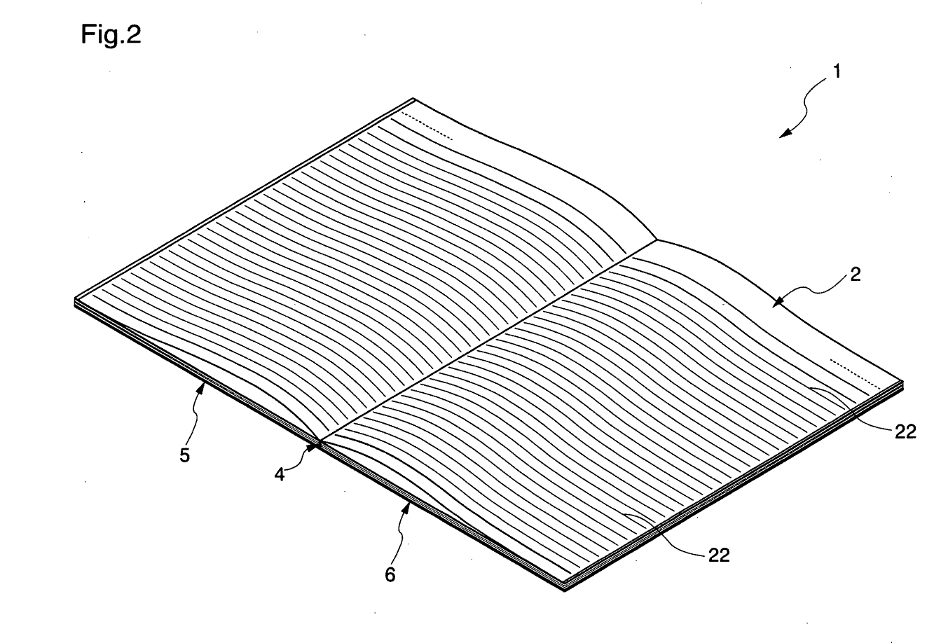

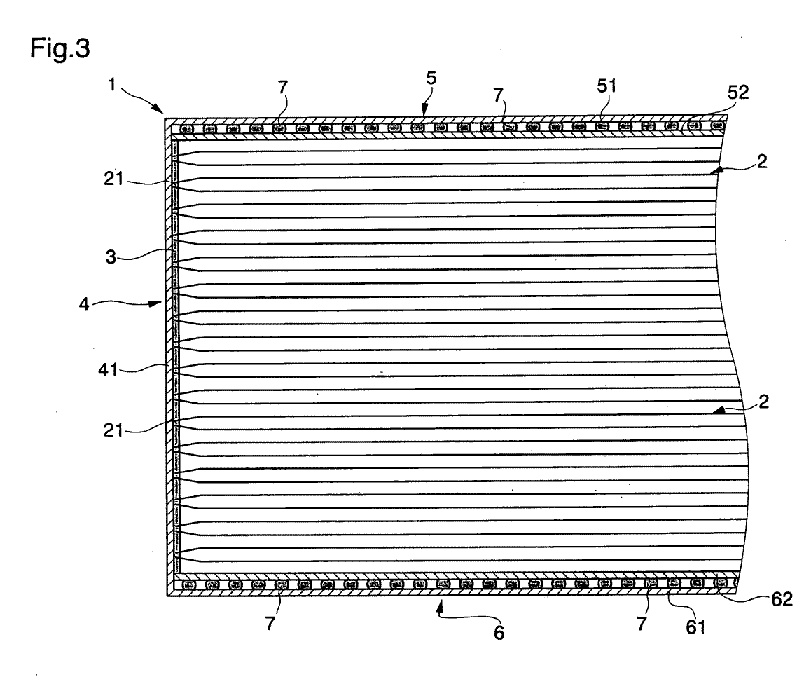

As illustrated in FIG. 2 and FIG. 3, a single unit of the leaves 2 is configured by a twofold sheet along a perforation 21 of a size corresponding to a specification of A4, B5, or the like in a rectangle shape or a substantially rectangle shape. A plurality of units of the leaves 2 are bound in a state in which a part of a cold type glue that forms the glue layer 3 is intruded into the perforations 21. In this case, the glue layer 3 is formed using an aqueous emulsion glue as one example of the cold type glue. The bound edges of the leaves 2 are directly coupled to the spine 4 via the flexible glue layer 3. In other words, a coupling portion of the leaves 2 with the spine 4 and the glue layer 3 is in an adhesive binding structure. Ruled lines 22 for writing are printed on each leaf 2. With this arrangement, the booklet 1 according to this embodiment is suitable in an application for a notebook for writing.

As illustrated in FIG. 3, the spine 4 is configured by a single flexible sheet that is directly in contact with the glue layer 3 (hereinafter referred to as a “flexible sheet for the spine 41”). In this embodiment, a paper sheet that is coated with a resin coating is used as a material of the flexible sheet for the spine 41.

As illustrated in FIG. 3, the front cover 5 and the back cover 6 are respectively configured by flexible sheets (hereinafter referred to as a “flexible sheet for the front cover 51” and a “flexible sheet for the back cover 61”) each continuing to the flexible sheet for the spine 41, and reinforcement sheets (hereinafter referred to as a “reinforcement sheet for the front cover 52” and a “reinforcement sheet for the back cover 62”) respectively layered on inner surfaces of the flexible sheet for the front cover 51 and the flexible sheet for the back cover 61. The reinforcement sheet for the front cover 52 and the reinforcement sheet for the back cover 62 each have a function of protecting the leaves 2 together with the flexible sheet for the front cover 51 and the flexible sheet for the back cover 61. In this embodiment, paperboards are adopted as the reinforcement sheet for the front cover 52 and the reinforcement sheet for the back cover 62. The paperboards are in a solid color, and preferably of patternless white. The flexible sheet for the front cover 51 and the flexible sheet for the back cover 61 are respectively applied to the reinforcement sheet for the front cover 52 and the reinforcement sheet for the back cover 62 using an adhesive (adhesive member) 7 containing no moisture. In this embodiment, the adhesive 7 is applied onto the inner surfaces of the flexible sheet for the front cover 51 and the flexible sheet for the back cover 61 in a dotted pattern (see FIG. 3). As the reinforcement sheets 52 and 62 are made of paper and the inner surfaces of the flexible sheets 41, 51, and 61 are also made of paper, an adhesive property for applying the flexible sheets 41, 51, and 61 to the reinforcement sheets 52 and 62 is sufficiently ensured.

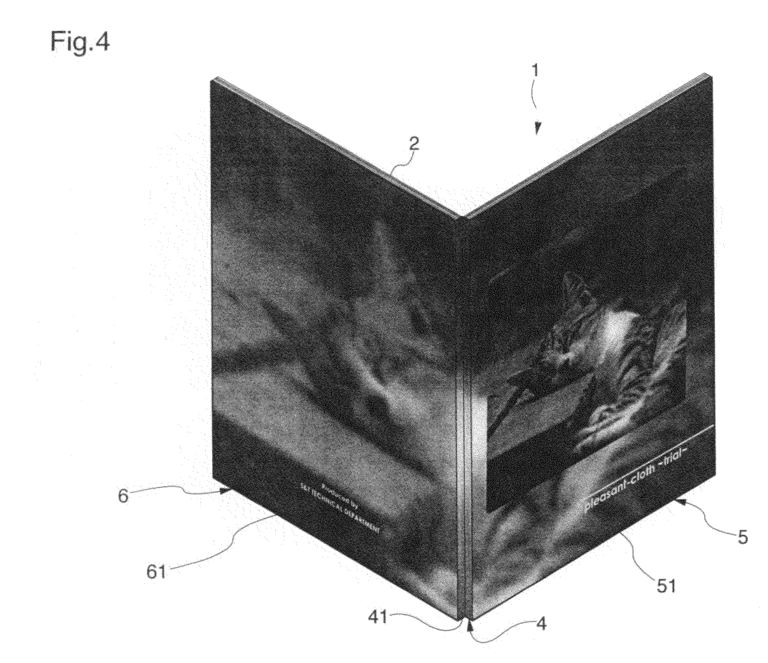

With the flexible sheet for the front cover 51, the flexible sheet for the spine 41, and the flexible sheet for the back cover 61 that are provided continuously to each other, each of the entire surface portions of the front cover 5 and the back cover 6 is provided continuously to an entire surface portion of the spine 4. Then, as illustrated in FIG. 4, data of a common image is printed continuously on the surfaces of the front cover 5, the spine 4, and the back cover 6 that are provided continuously to each other. In other words, the data of the common image is printed continuously on the surfaces of the flexible sheet for the front cover 51, the flexible sheet for the spine 41, and the flexible sheet for the back cover 61. Further, in this embodiment, character strings are respectively printed on the surfaces of the front cover 5 and the back cover 6. It should be noted that, in addition to or instead of printing the data of the common image continuously on the surfaces of the front cover 5, the spine 4, and the back cover 6, it is possible to provide common surface processing, such as embossing or making the surfaces to look like real leather or cloth, to the front cover 5, the spine 4, and the back cover 6 in order to respond to various design demands for an appearance of the booklet 1.

In the booklet 1 according to this embodiment thus configured, as illustrated in FIG. 4 to FIG. 6, the spine 4 itself is flexibly deformed due to a property of the flexible glue layer 3 when opening desired ones of the leaves 2. FIG. 4 is a view illustrating the booklet 1 substantially in an intermediate state between a closed state and the two-page spread state when viewed from a rear side.

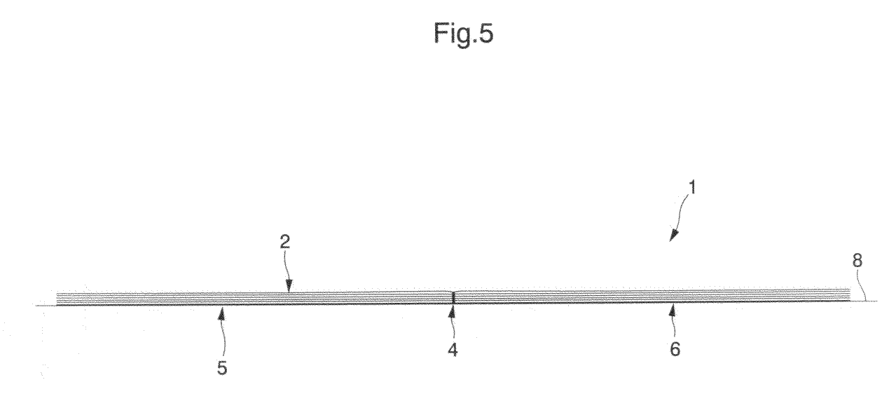

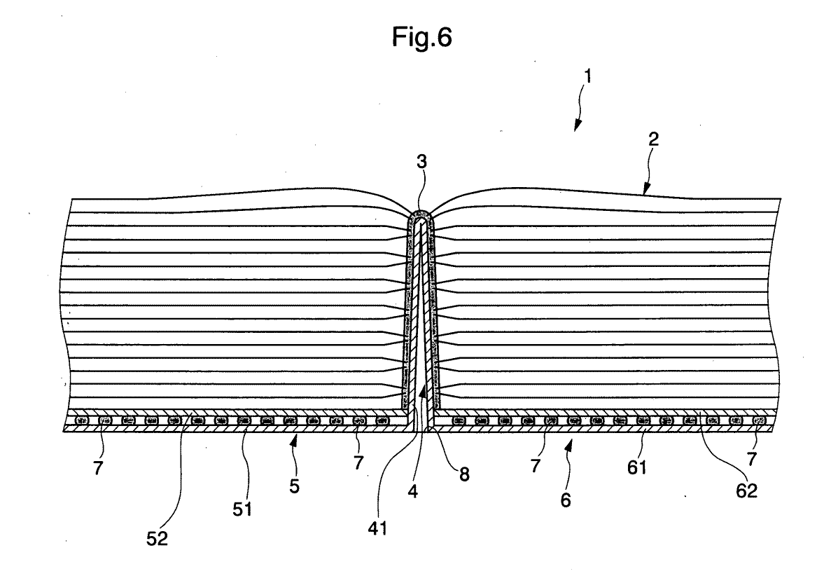

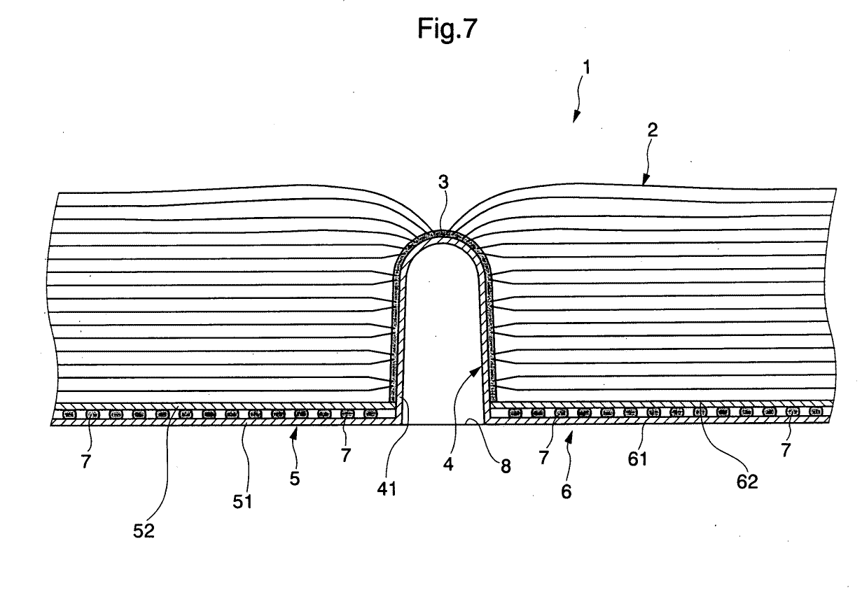

Then, as illustrated in FIG. 5, a flexural strength of the spine 4 backed by the glue layer 3 is set such that the spine 4 can be flexibly deformed inwardly at a near acute angle together with the bound edges of the leaves 2 when center pages of the leaves 2 are spread. It should be noted that a concept of the description “flexibly deformed inwardly at a near acute angle” includes not only an event in which the spine is flexibly deformed inwardly at an acute angle as illustrated in FIG. 6, but also an event in which the spine is flexibly deformed inwardly at a near acute angle such that the flexed portion is round as illustrated in FIG. 7. In other words, the description “can be flexibly deformed inwardly at a near acute angle” means both an event in which the spine can be flexibly deformed inwardly in a V-shaped or substantially V-shaped manner, and an event in which the spine can be flexibly deformed inwardly in a U-shaped or substantially U-shaped manner. Further, the concept of the description “flexibly deformed inwardly at a near acute angle” also includes an event in which a flexed angle of the flexed portion is 0 degrees or smaller (not illustrated in the drawings), as long as the flexed angle of the flexed portion is smaller than 90 degrees.

Moreover, as illustrated in FIG. 5 to FIG. 7, the booklet 1 is configured so as to be able to spread such that the entire area of the front cover 5 and the entire area of the back cover 6 are substantially flush with each other when center pages of the leaves 2 are spread. The description “able to spread such that the entire area of the front cover 5 and the entire area of the back cover 6 are substantially flush with each other” means both an event in which the entire area of the front cover 5 and the entire area of the back cover 6 are substantially in close contact with a common flat plane 8 under their own weights when spread in two pages, and an event in which the entire area of the front cover 5 and the entire area of the back cover 6 are substantially brought into close contact with the common flat plane 8 by pressing the booklet 1 with a strength that may not damage the booklet 1 in addition to their own weights.

As described above, according to the booklet 1 of this embodiment, as the flexural strength of the spine 4 backed by the glue layer 3 is set such that the spine 4 can be flexibly deformed inwardly at a near acute angle together with the bound edges of the leaves 2 when center pages of the leaves 2 are spread, it is possible to ensure favorable two-page spread quality, and to eliminate a production step of binding the plurality of leaves 2 using a thread, thereby reducing the cost in comparison with case-bound books. In addition, as the entire areas of the surface portions of the front cover 5, the spine 4, and the back cover 6 are provided continuously to each other, it is possible to flexibly change the appearance of the booklet 1 in response to various design demands by printing the data of the common image continuously over the front cover 5, the spine 4, and the back cover 6, or by providing the common surface processing (such as embossing or making the surfaces to look like real leather or cloth), and whereby it is possible to provide the booklet 1 with a high value added, such as an unconventional booklet or a high-grade booklet.

In particular, as each single unit of the leaves 2 is configured by a twofold sheet along the perforation 21, and the plurality of units of leaves 2 are bound in the state in which the part of the cold type glue that forms the glue layer 3 is intruded into the perforations 21, it is possible to improve the coupling strength between each leaf 2 and the spine 4 while ensuring flexibility to a magnitude in which the spine 4 is flexed when spread in two pages, providing superior durability.

Further, as the spine 4 is configured by the single flexible sheet for the spine 41 that is directly in contact with the glue layer 3, and the front cover 5 and the back cover 6 are respectively configured by the flexible sheet for the front cover 51 and the flexible sheet for the back cover 61 each continuing to the flexible sheet for the spine 41, and the reinforcement sheet for the front cover 52 and the reinforcement sheet for the back cover 62 respectively layered on the inner surfaces of the flexible sheets 51 and 61, it is possible to simplify the structure of the spine 4 itself, as well as to effectively exert together with the spine 4 a protective function for the leaves 2 by the front cover 5 and the back cover 6 that are two-layered.

The entire areas or substantially entire areas of the flexible sheet for the front cover 51 and the flexible sheet for the back cover 61 are respectively applied to the reinforcement sheet for the front cover 52 and the reinforcement sheet for the back cover 62 using the adhesive 7 containing no moisture, it is possible to prevent occurrence of an unnecessary warpage of the front cover 5 and the back cover 6 that may occur in a case where an adhesive containing moisture is used. In addition, as the adhesive 7 is applied in the dotted pattern, it is possible to let air to escape in application with no bubbles being left, thereby forming the front cover 5 and the back cover 6 with a clean finish.

Further, as each leaf 2 is provided with the ruled lines 22 for writing, the booklet 1 for writing is configured to include writing areas secured by the ruled lines 22, as the booklet 1 suitable in an application for a notebook, and easiness in writing can be significantly improved by excellent two-page spread quality.

In addition, as the flexural strength of the spine 4 backed by the glue layer 3 is set such that, when center pages of the leaves 2 are spread, the spine 4 can be flexibly deformed at a near acute angle and the entire area of the front cover 5 and the entire area of the back cover 6 are substantially flush with each other, the entire areas or the substantially entire areas of the front cover 5 and the back cover 6 are in contact with the common flat plane 8 when spread in two pages over the common flat plane 8, and therefore it is possible to further improve the two-page spread quality, to stably maintain a two-page spread state, and, in particular, to facilitate smooth and appropriate writing to a portion near the bound edges of the leaves 2.

### Second Embodiment

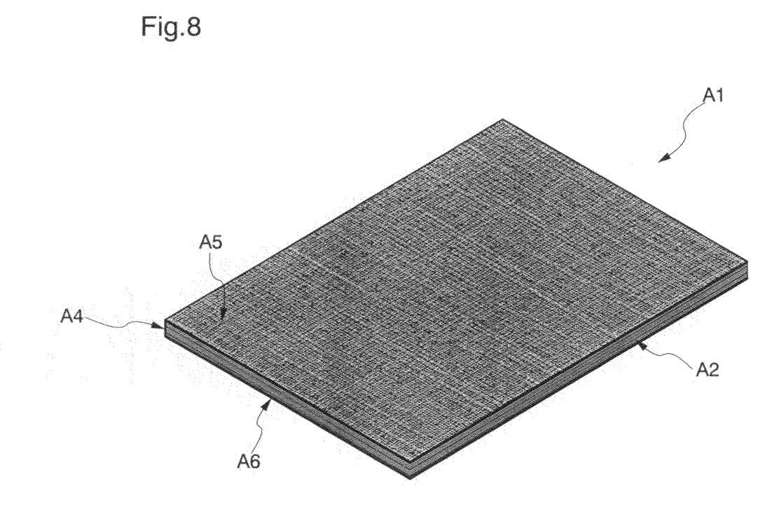

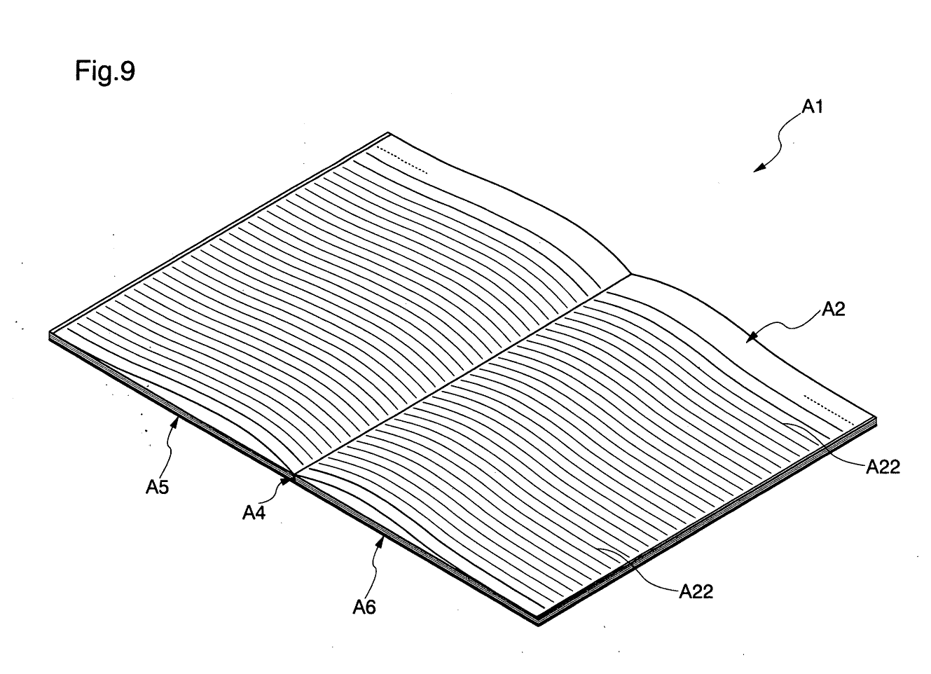

A booklet A1 according to a second embodiment is different from the booklet 1 according to the first embodiment in that, as illustrated in FIG. 8 to FIG. 10 and the like, a spine A4 is configured by an inner flexible sheet for the spine (hereinafter referred to as an “inner flexible sheet for the spine A41”) which is directly in contact with a glue layer A3 and an outer flexible sheet for the spine (hereinafter referred to as an “outer flexible sheet for the spine A42”) which is applied to a surface of the inner flexible sheet for the spine A41, and a front cover A5 and a back cover A6 are respectively configured by flexible sheets (hereinafter respectively referred to as a “flexible sheet for the front cover A51” and a “flexible sheet for the back cover A61”) each continuing to the outer flexible sheet for the spine A42 and reinforcement sheets (hereinafter respectively referred to as a “reinforcement sheet for the front cover A52” and a “reinforcement sheet for the back cover A62”) respectively layered on inner surfaces of the flexible sheets A51 and A61. In the following description and in FIG. 8 to FIG. 14, components that correspond to the components of the booklet 1 according to the first embodiment are indicated by reference symbols prefixed with “A”.

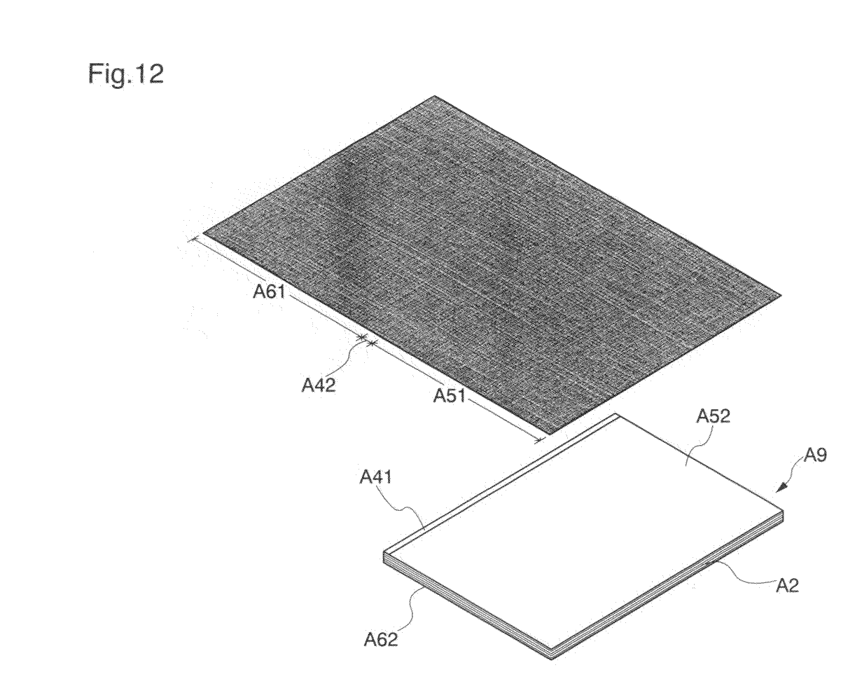

Specifically, the booklet A1 according to the second embodiment is provided with a booklet main body A9 configured by a plurality of leaves A2, the inner flexible sheet for the spine A41 in a thin paper form which couples bound edges of the leaves A2 via the flexible glue layer A3, the reinforcement sheet for the front cover A52 of which outer end surface on the side of the bound edges is joined to one end edge of the inner flexible sheet for the spine A41, and the reinforcement sheet for the back cover A62 of which outer end surface on the side of the bound edges is joined to the other end edge of the inner flexible sheet for the spine A41 (see FIG. 12).

The leaves A2 are the same or substantially the same as those described in the first embodiment in that each single unit of the leaves A2 is configured by a twofold sheet along a perforation A21, that the leaves 2 are bound in a state in which a part of a cold type glue that forms the glue layer A3 is intruded into the perforations A21, and that a plurality of ruled lines A22 for writing are printed on the leaves A2, and therefore a detailed explanation will not be repeated.

The inner flexible sheet for the spine A41 is thinner and softer than the outer flexible sheet for the spine A42. In this embodiment, the inner flexible sheet A41 is not able to exert a leaf binding strength sufficiently durable for a single use. In this embodiment, both end edges of the inner flexible sheet for the spine A41 are flexed so as to be layered over the outer end surfaces of the reinforcement sheet for the front cover A52 and the reinforcement sheet for the back cover A62 on the side of the bound edges.

The reinforcement sheet for the front cover A52 and the reinforcement sheet for the back cover A62 are made of paperboards, respectively. The paperboards are in a solid color, and preferably of patternless white. The outer end surfaces of the reinforcement sheet for the front cover A52 and the reinforcement sheet for the back cover A62 on the side of the bound edges to be layered on the end edges of the flexed inner flexible sheet for the spine A41 are applied to the end edges of the inner flexible sheet for the spine A41. The inner flexible sheet A41 and the reinforcement sheets A52 and A62 are each made of paper, and an adhesive property for adhering to each other is sufficiently ensured.

The booklet main body A9 thus configured does not have durability that is sufficiently suitable for a single use, as the inner flexible sheet for the spine A41 does not exert the leaf binding strength sufficiently durable for a single use, but is unitized by the inner flexible sheet for the spine A41.

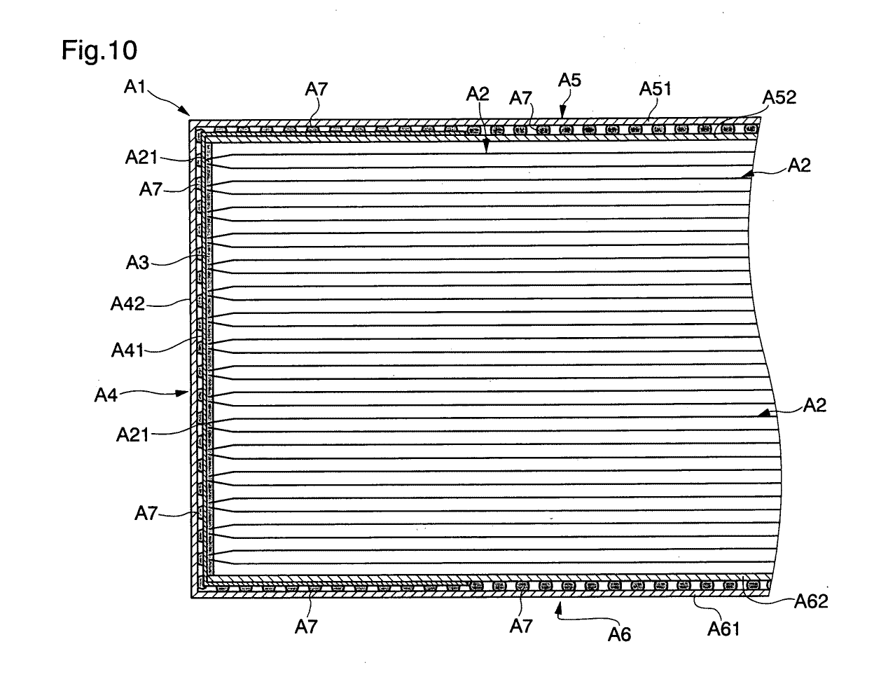

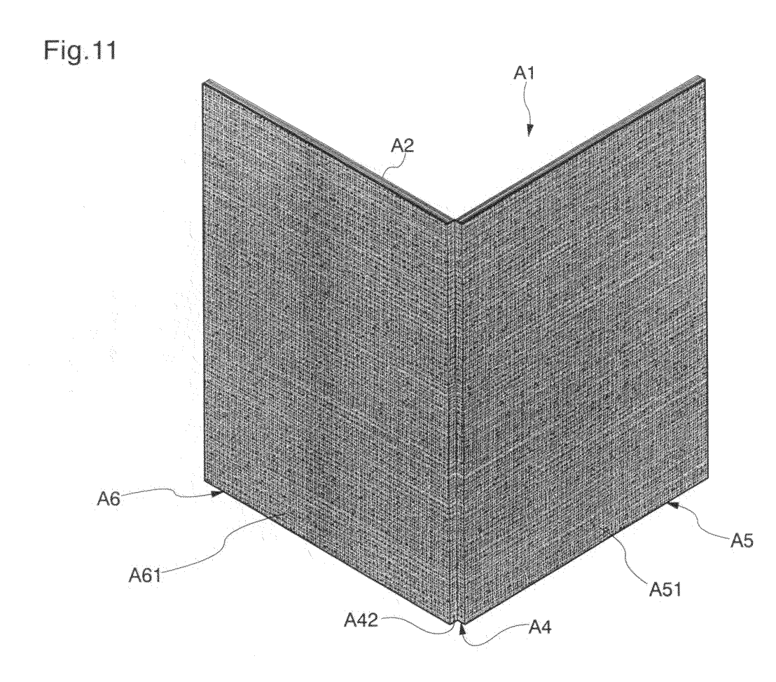

Then, as illustrated in FIG. 11 and FIG. 12, the flexible sheet for the front cover A51, the outer flexible sheet for the spine A42, and the flexible sheet for the back cover A61 that are provided continuously to each other are applied to the entire area or the substantially entire area of the outer surface of the booklet main body A9, thereby configuring the booklet A1 having durability that is sufficiently suitable for a use. Specifically, the flexible sheet for the front cover A51, the outer flexible sheet for the spine A42, and the flexible sheet for the back cover A61 that are provided continuously to each other are applied to the entire area or the substantially entire area of the outer surface of the booklet main body A9, using an adhesive A7 containing no moisture. In this embodiment, the adhesive A7 is applied onto the inner surfaces of the flexible sheet for the front cover A51, the outer flexible sheet for the spine A42, and the flexible sheet for the back cover A61 in a dotted pattern (see FIG. 10). A paper sheet that is coated with a resin coating is used as a common material of the flexible sheet for the front cover A51, the outer flexible sheet for the spine A42, and the flexible sheet for the back cover A61. As the inner flexible sheet A41 is extremely thin, there is only a very small difference in height between the outer surface of the inner flexible sheet A41 and the outer surfaces of the reinforcement sheets A52 and A62, and the outer flexible sheets A51 and A61 that are applied to each other does not include any significant difference in height (due to the difference in height between the outer surface of the inner flexible sheet A41 and the outer surfaces of the reinforcement sheets A52 and A62). All of the inner flexible sheet A41, the reinforcement sheets A52 and A62, and the inner surfaces of the outer flexible sheets A42, A51 and A61 are made of paper, and the adhesive property when applying the outer flexible sheets A42, A51 and A61 to the inner flexible sheet A41 and the reinforcement sheets A52 and A62 is sufficiently ensured.

With the flexible sheet for the front cover A51, the outer flexible sheet for the spine A42, and the flexible sheet for the back cover A61 that are provided continuously to each other, each of entire surface portions of both the front cover A5 and the back cover A6 continues to an entire surface portion of the spine A4. Then, as illustrated in FIG. 11 and FIG. 12, data of a common image is printed continuously on the surfaces of the front cover A5, the spine A4, and the back cover A6 that are provided continuously to each other. In other words, the data of the common image is printed continuously on the surfaces of the flexible sheet for the front cover A51, the outer flexible sheet for the spine A42, and the flexible sheet for the back cover A61. Further, in this embodiment, character strings are respectively printed on the surfaces of the flexible sheet for the front cover A51 and the flexible sheet for the back cover A61. It should be noted that, in addition to or instead of printing the data of the common image continuously on the surfaces of the front cover A5, the spine A4, and the back cover A6, it is possible to provide common surface processing, such as embossing or making the surfaces to look like real leather or cloth, to the front cover A5, the spine A4, and the back cover A6 in order to respond to various design demands for an appearance of the booklet A1.

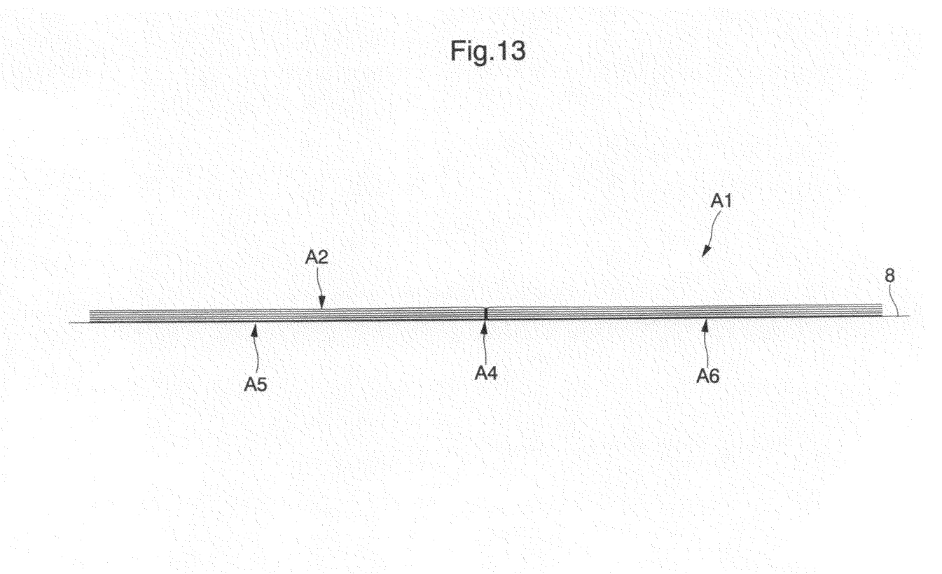

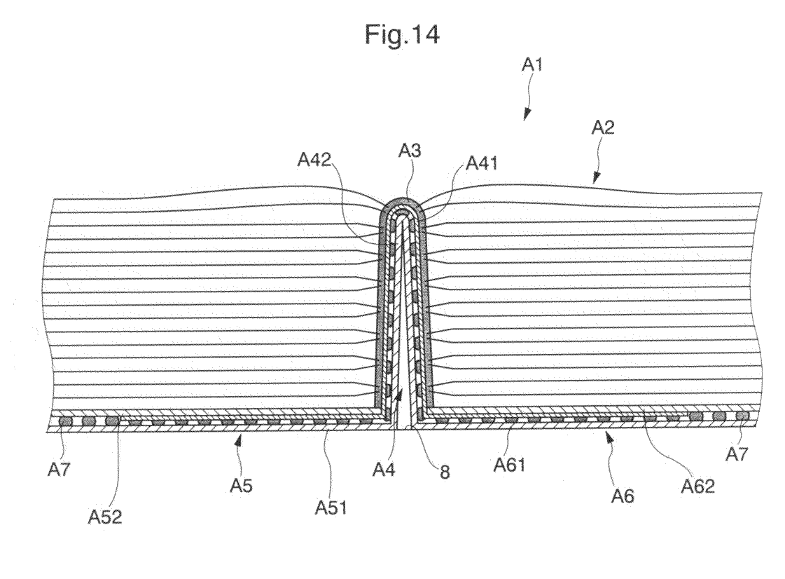

In the booklet A1 according to this embodiment thus configured, as illustrated in FIG. 11, FIG. 13, and FIG. 14, the spine A4 itself is flexibly deformed due to a property of the flexible glue layer A3 when opening desired ones of the leaves A2. FIG. 11 is a view illustrating the booklet A1 substantially in an intermediate state between a closed state and the two-page spread state when viewed from a rear side.

Then, as illustrated in FIG. 13, a flexural strength of the spine A4 backed by the glue layer A3 is set such that the spine A4 can be flexibly deformed inwardly at a near acute angle together with the bound edges of the leaves A2 when center pages of the leaves A2 are spread. It should be noted that a concept of the description “flexibly deformed inwardly at a near acute angle” includes not only an event in which the spine is flexibly deformed inwardly at an acute angle as illustrated in FIG. 14, but also an event in which the spine is flexibly deformed inwardly at a near acute angle such that the flexed portion is round (not illustrated in the drawings). In other words, the description “can be flexibly deformed inwardly at a near acute angle” means both an event in which the spine can be flexibly deformed inwardly in a V-shaped or substantially V-shaped manner, and an event in which the spine can be flexibly deformed inwardly in a U-shaped or substantially U-shaped manner. Further, the concept of the description “flexibly deformed inwardly at a near acute angle” also includes an event in which a flexed angle of the flexed portion is 0 degrees or smaller (not illustrated in the drawings), as long as the flexed angle of the flexed portion is smaller than 90 degrees.

Moreover, the booklet A1 is configured so as to be able to spread such that the entire area of the front cover A5 and the entire area of the back cover A6 are substantially flush with each other when center pages of the leaves A2 are spread. The description “able to spread such that the entire area of the front cover A5 and the entire area of the back cover A6 are substantially flush with each other” means both an event in which the entire area of the front cover A5 and the entire area of the back cover A6 are substantially in close contact with the common flat plane 8 under their own weights when spread in two pages, and an event in which the entire area of the front cover A5 and the entire area of the back cover A6 are substantially brought into close contact with the common flat plane 8 by pressing the booklet A1 with a strength that may not damage the booklet A1, in addition to their own weights.

As described above, according to the booklet A1 of the second embodiment, similarly to the booklet 1 of the first embodiment, as the flexural strength of the spine A4 backed by the glue layer A3 is set such that the spine A4 can be flexibly deformed inwardly at a near acute angle together with the bound edges of the leaves A2 when center pages of the leaves A2 are spread, it is possible to ensure favorable two-page spread quality, and to eliminate a production step of binding the plurality of leaves 2 using a thread, thereby reducing the cost in comparison with case-bound books. In addition, as the entire areas of the surface portions of the front cover A5, the spine A4, and the back cover A6 are provided continuously to each other, it is possible to flexibly change the appearance of the booklet A1 in response to various design demands by printing the data of the common image continuously over the front cover A5, the spine A4, and the back cover A6 or by providing the common surface processing (such as embossing or making the surfaces to look like real leather or cloth), and whereby it is possible to provide the booklet A1 with a high value added, such as an unconventional booklet or a high-grade booklet.

Further, as the spine A4 is configured by the inner flexible sheet for the spine A41 which is directly in contact with the glue layer A3 and the outer flexible sheet for the spine A42 which is applied to the outer surface of the inner flexible sheet for the spine A41, and the front cover A5 and the back cover A6 are respectively configured by the flexible sheet for the front cover A51 and the flexible sheet for the back cover A61 each continuing to the outer flexible sheet for the spine A42, and the reinforcement sheet for the front cover A52 and the reinforcement sheet for the back cover A62 respectively layered on the inner surfaces of the flexible sheets A51 and A61, it is possible to effectively exert a protective function for the leaves A2 by the spine A4, the front cover A5, and the back cover A6 that are two-layered.

Moreover, as the booklet main body A9 is configured by the plurality of leaves A2, the inner flexible sheet for the spine A41 which couples bound edges of the leaves A2 via the flexible glue layer A3, the reinforcement sheet for the front cover A52 of which outer end surface on the side of the bound edges is joined to one end edge of the inner flexible sheet for the spine A41, and the reinforcement sheet for the back cover A62 of which outer end surface on the side of the bound edges is joined to the other end edge of the inner flexible sheet for the spine A41, and as the flexible sheet for the front cover A51, the outer flexible sheet for the spine A42, and the flexible sheet for the back cover A61 that are provided continuously to each other are applied to the entire area of the outer surface of the booklet main body A9, it is possible to produce the unitized booklet main bodies A9 in advance, and to produce the booklets 1 of the number as required by each applying, to the booklet main body A9, the flexible sheet for the front cover A51, the outer flexible sheet for the spine A42, and the flexible sheet for the back cover A61 that are provided continuously to each other and redesigned on demand, thereby reducing inventory risk.

In particular, as the spine A4 is configured by the outer flexible sheet for the spine A42 and the inner flexible sheet for the spine A41 that is thinner than the outer flexible sheet for the spine A42 and that does not exert the leaf binding strength sufficiently durable in a single use, the booklet main body A9 can be unitized by the inner flexible sheet for the spine A41, and the outer flexible sheet for the spine A42 can function as a backup member for the inner flexible sheet for the spine A41, thereby providing the booklet 1 having good durability.

Further, as the flexible sheet for the front cover A51, the outer flexible sheet for the spine A42, and the flexible sheet for the back cover A61 that are provided continuously to each other are applied to the entire area of the outer surface of the booklet main body A9 using the adhesive A7 containing no moisture, it is possible to prevent occurrence of an unnecessary warpage of the front cover 5 and the back cover 6 that may occur in a case where an adhesive containing moisture is used. In addition, as the adhesive A7 is applied to the inner surfaces of the flexible sheet for the front cover A51, the outer flexible sheet for the spine A42, and the flexible sheet for the back cover A61 in the dotted pattern, it is possible to let air to escape in application with no bubbles being left, thereby forming the front cover A5, the spine A4, and the back cover A6 with a clean finish.

Further, as the paper sheet that is coated with the resin coating is used as the material of the flexible sheet for the front cover A51, the outer flexible sheet for the spine A42, and the flexible sheet for the back cover A61 that are provided continuously to each other, it is possible to provide the booklet A1 with good texture and hand feeling.

Provided effects that are similar to those provided by the booklet 1 according to the first embodiment are an effect in which, as each single unit of the leaves A2 is configured by the twofold sheet along the perforation A21, and as the plurality of units of leaves A2 are bound in the state in which the part of the cold type glue that forms the glue layer A3 is intruded into the perforations A21, it is possible to improve the coupling strength between each leaf A2 and the spine A4 while ensuring flexibility to a magnitude in which the spine A4 is flexed when spread in two pages, thereby providing superior durability, and an effect in which, as each leaf A2 includes the ruled lines A22 for writing, the booklet A1 for writing is configured to include writing areas secured by the ruled lines A22, as the booklet A1 suitable in an application for a notebook, and easiness in writing can be significantly improved by excellent two-page spread quality.

In addition, as the flexural strength of the spine A4 backed by the glue layer A3 is set such that, when center pages of the leaves A2 are spread, the spine A4 can be flexibly deformed at a near acute angle and the entire area of the front cover A5 and the entire area of the back cover A6 are substantially flush with each other, the entire areas or the substantially entire areas of the front cover A5 and the back cover A6 are in contact with the common flat plane 8 when spread in two pages over the common flat plane 8, and therefore it is possible to further improve the two-page spread quality, to stably maintain a two-page spread state, and, in particular, to facilitate smooth and appropriate writing onto an area near the bound edges of the leaves A2.

The following complementarily describes the flexibility and the two-page spread quality that should be provided to the spines 4 and A4 of the booklets 1 and A1, respectively. The following experimentation is carried out using as test pieces samples (1) and (2) having equivalent structures as those of the booklets 1 and A1 and samples (3), (4), and (5) of conventional books bound using a hot-melt glue. The samples are in a size such that a width of the front cover is 120 mm and a height of the front cover is 90 mm, the number of leaves of the sample (1) is 30, the number of leaves of the sample (2) is 100, the number of leaves of the sample (3) is 96, the number of leaves of the sample (4) is 88, and the number of leaves of the sample (5) is 24. Further, widths across the backs of the samples, i.e. values for thicknesses t of the booklets 1 and A1, are 3.9 mm for the sample (1), 10.8 mm for the sample (2), 6.5 mm for the sample (3), 9.5 mm for the sample (4), and 2.9 mm for the sample (5), respectively.

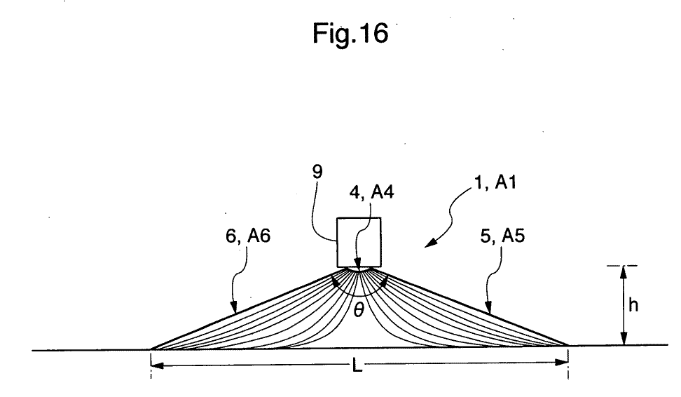

These samples are placed on a metallic plane having a flat and even surface with opening substantially center pages of the booklets 1 and A1 and with the spines 4 and A4 upside in an environment of a room temperature of 23° C. and humidity of 50%. Then, in a state in which a weight 9 of a predetermined weight is placed thereon, a spread width L from an outer edge of the front cover to an outer edge of the back cover, and a height h from the flat plane to an upper edge of each of the spines 4 and A4 as illustrated in FIG. 16 are measured. In this case, the weight 9 weighs 100 gf. Further, a spread angle θ is calculated based on the measured spread width L and the measured height h. A simple calculation equation for the spread angle θ is as follows.

θ≈2 tan⁻¹{(L/2)/h}=2 tan⁻¹(L/2h)

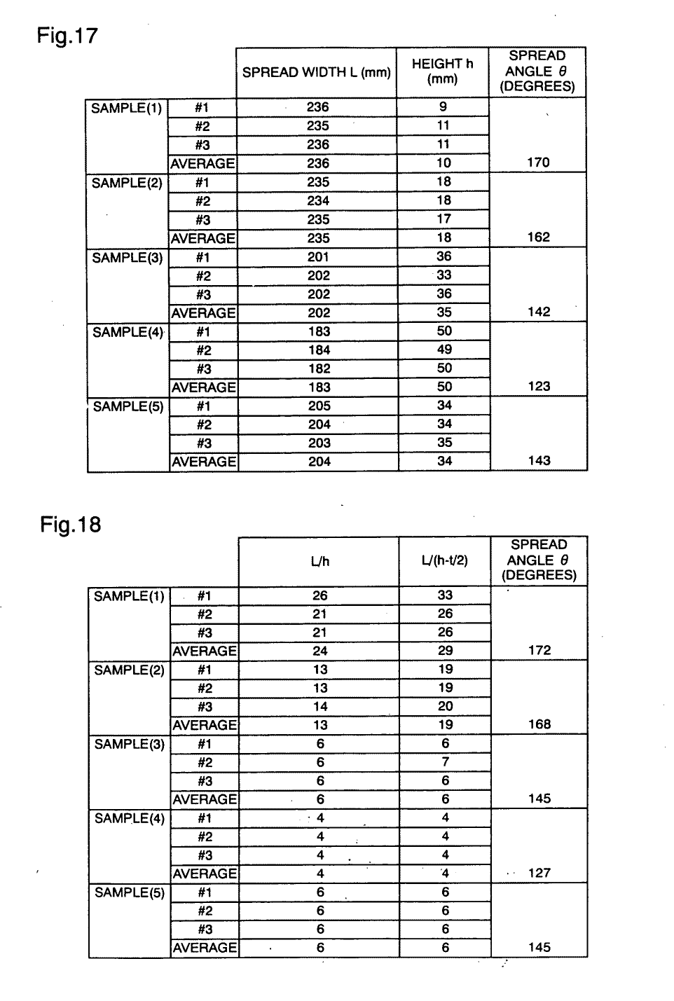

Results of the experimentation in which three booklets are prepared for each of the samples (1), (2), (3), (4), and (5) are illustrated in FIG. 17. When the weight 9 is placed on each of the samples, the height h of the samples (1) and (2) that are bound using a cold glue is about ½ to 1/10 of the height in a case where no weight is placed. On the other hand, the height h of the samples (3), (4), and (5) that are bound using a hot-melt glue is about ½ to ⅓. In general, the height h is higher and the spread angle θ is smaller in the book bound using a hot-melt glue.

It is possible to calculate the more accurate spread angle θ, by additionally evaluating the width t across the backs of the samples (ideally, based on h=t/2 where the spread angle θ is 180 degrees). In this case, a calculation equation for the spread angle θ is as follows.

θ≈2 tan⁻¹{(L/2)/(h−t/2)}=2 tan⁻¹{L/(2h−t)}

More accurate spread angles θ of the samples (1), (2), (3), (4), and (5) are illustrated in FIG. 18.

The samples (1) and (2) provide better usability as a notebook or the like than the samples (3), (4), and (5). Accordingly, the flexibility of each of the spines 4 and A4 of the booklets 1 and A1, that is, the flexural strength of each of the spines 4 and A4 is desirably set such that the spread angle θ calculated using the spread width L and the height h when the weight 9 of 100 gf is placed on each of the spines 4 and A4 is equal to or greater than 150 degrees, and more preferably from 160 degrees to 180 degrees.

In the above description, the flexural strength of each of the spines 4 and A4 is defined taking the spread angle θ as an index, but the flexural strength of each of the spines 4 and A4 can be defined taking a ratio between L and h or a ratio between L and (h−t/2) as an index. Values for L/h and L/(h−t/2) are illustrated in FIG. 18. These ratios are desirably 10 at minimum, and, in particular, L/(h−t/2) is desirably equal to or greater than 18 to 20.

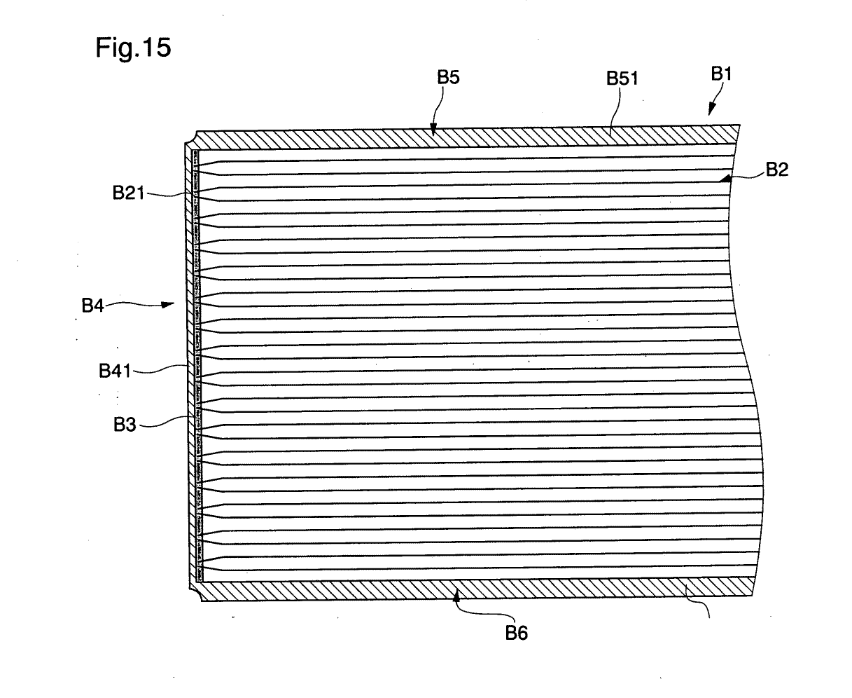

It should be noted that the present invention is not particularly limited to the embodiments described above in detail. For example, as illustrated in FIG. 15, a spine B4 can be configured by a single resin flexible sheet B41 that is directly in contact with a glue layer B3, and a front cover B5 and a back cover B6 can be respectively configured by single resin flexible sheets B51 and B61 each continuing to the flexible sheet B41 of the spine 4. In this case, by setting the flexible sheet for the spine B41 to be thinner than the flexible sheet for the front cover B51 and the flexible sheet for the back cover B61, it is possible to ensure deformability of the spine B4 when spread in two pages (FIG. 15 illustrates an example in which the flexible sheet for the spine B41, the flexible sheet for the front cover B51, and the flexible sheet B61 of the back cover 6 all have the same thickness). In FIG. 15, components that correspond to the components of the booklet 1 according to the first embodiment are indicated by reference symbols prefixed with “B”.

Further, an application other than the application for a notebook can be possible, for example, an application for a booklet suitable as diary or an appointment organizer, or a booklet that is mainly used for browsing such as a brochure. The design of the leaves can be appropriately changed so as to meet the application.

It is possible to use a glue other than the aqueous emulsion as the flexible glue that forms the glue layer. Further, it is possible to use a glue other than the cold type glue as long as the flexibility and the two-page spread quality as illustrated in FIG. 6, FIG. 7, FIG. 14, and FIG. 17 can be ensured. An agglutinated glue is not a cold type glue, but is one example that can realize the flexibility necessary in implementation of the present invention.

Furthermore, the specific structures of the components are not limited to those according to the embodiments described above, and various modifications can be made within the spirit of the present invention.

### INDUSTRIAL APPLICABILITY

The present invention can be applied to, for example, notebooks for writing, diaries, and appointment organizers, or booklets that are mainly used for browsing such as brochures.

### DESCRIPTION OF SYMBOLS

1, A1, B1 Booklet
2, A2, B2 Leaf
21, A21, B21 Perforation
22, A22 Ruled Line
3, A3, B3 Glue Layer
4, A4, B4 Spine
Flexible Sheet for Spine
5, A5, B5 Front Cover
51, A51 Flexible Sheet for Front Cover
52, A52 Reinforcement Sheet for Front Cover
6, A6, B6 Back Cover
61, A61 Flexible Sheet for Back Cover
62, A62 Reinforcement Sheet for Back Cover
7, A7 Adhesive
A41 Inner Flexible Sheet for Spine
A42 Outer Flexible Sheet for Spine
A9 Booklet Main Body

1. A booklet comprising:
a plurality of leaves;
a spine that couples bound edges of the leaves via a flexible glue layer; and
a front cover and a back cover each having at least an entire area of a surface portion continuing to an entire area of a surface portion of the spine, wherein
a flexural strength of the spine backed by the glue layer is set such that the spine is flexibly deformed inwardly at a near acute angle together with the bound edges of the leaves when center pages of the leaves are spread.

2. The booklet according to claim 1, wherein
a coupling portion of the leaves with the spine and the glue layer constitutes an adhesive binding structure.

3. The booklet according to claim 2, wherein
a plurality of units of leaves, each unit being configured by a twofold sheet along a perforation, are bound in a state in which a part of a cold type glue that forms the glue layer is intruded into the perforations.

4. The booklet according to claim 1, wherein
the spine is configured by a single flexible sheet that is directly in contact with the glue layer, and the front cover and the back cover are respectively configured by flexible sheets each continuing to the flexible sheet for the spine, and reinforcement sheets respectively layered on inner surfaces of the flexible sheets.

5. The booklet according to claim 1, wherein
the spine is configured by an inner flexible sheet for the spine which is directly in contact with the glue layer and an outer flexible sheet for the spine which is applied to an outer surface of the inner flexible sheet, and the front cover and the back cover are respectively configured by flexible sheets each continuing to the outer flexible sheet for the spine and reinforcement sheets respectively layered on inner surfaces of the flexible sheets.

6. The booklet according to claim 5, wherein
the plurality of leaves, the inner flexible sheet for the spine which couples the bound edges of the leaves via the flexible glue layer, the reinforcement sheet for the front cover of which outer end surface on a side of the bound edges is joined to one end edge of the inner flexible sheet, and the reinforcement sheet for the back cover of which outer end surface on the side of the bound edges is joined to another end edge of the inner flexible sheet constitute a booklet main body, and
the flexible sheet for the front cover, the outer flexible sheet for the spine, and the flexible sheet for the back cover which are provided continuously to each other are applied to an entire area of an outer surface of the booklet main body.

7. The booklet according to claim 5, wherein
the spine is configured by the outer flexible sheet and the inner flexible sheet that is thinner than the outer flexible sheet.

8. The booklet according to claim 6, wherein
the flexible sheet for the front cover, the outer flexible sheet for the spine, and the flexible sheet for the back cover which are provided continuously to each other are applied to the entire area of the outer surface of the booklet main body using an adhesive containing no moisture.

9. The booklet according to claim 8, wherein
the adhesive is applied to the inner surfaces of the flexible sheet for the front cover, the outer flexible sheet for the spine, and the flexible sheet for the back cover in a dotted pattern.

10. The booklet according to claim 4, wherein
a material of the flexible sheet is paper coated with a resin coating.

11. The booklet according to claim 1, wherein
each of the leafs is provided with ruled lines for writing.

12. A booklet comprising:
a plurality of leaves;
a spine that couples bound edges of the leaves via a flexible glue layer; and
a front cover and a back cover each having at least an entire area of a surface portion continuing to an entire area of a surface portion of the spine, wherein
a flexural strength of the spine backed by the glue layer is set such that, when center pages of the leaves are spread, the spine is flexibly deformed inwardly at a near acute angle and an entire area of the front cover and an entire area of the back cover are substantially flush with each other.

13. The booklet according to claim 1, wherein
the flexural strength of the spine backed by the glue layer is set such that a spread width between the front cover and the back cover and a height of the covers from a flat plane are measured in a state in which a weight of 100 gf is placed on the booklet that is placed on the plane having a flat and even surface with the glue layer upside, and a spread angle calculated using the spread width and the height is from 150 degrees to 180 degrees.

14. The booklet according to claim 2, wherein
the spine is configured by a single flexible sheet that is directly in contact with the glue layer, and the front cover and the back cover are respectively configured by flexible sheets each continuing to the flexible sheet for the spine, and reinforcement sheets respectively layered on inner surfaces of the flexible sheets.

15. The booklet according to claim 2, wherein
the spine is configured by an inner flexible sheet for the spine which is directly in contact with the glue layer and an outer flexible sheet for the spine which is applied to an outer surface of the inner flexible sheet, and the front cover and the back cover are respectively configured by flexible sheets each continuing to the outer flexible sheet for the spine and reinforcement sheets respectively layered on inner surfaces of the flexible sheets.

16. The booklet according to claim 6, wherein
the spine is configured by the outer flexible sheet and the inner flexible sheet that is thinner than the outer flexible sheet.

17. The booklet according to claim 7, wherein
the flexible sheet for the front cover, the outer flexible sheet for the spine, and the flexible sheet for the back cover which are provided continuously to each other are applied to the entire area of the outer surface of the booklet main body using an adhesive containing no moisture.

18. The booklet according to claim 5, wherein
a material of the flexible sheet is paper coated with a resin coating.

19. The booklet according to claim 2, wherein
each of the leafs is provided with ruled lines for writing.

20. The booklet according to claim 2, wherein
the flexural strength of the spine backed by the glue layer is set such that a spread width between the front cover and the back cover and a height of the covers from a flat plane are measured in a state in which a weight of 100 gf is placed on the booklet that is placed on the plane having a flat and even surface with the glue layer upside, and a spread angle calculated using the spread width and the height is from 150 degrees to 180 degrees.
